(19) United States
(12) Patent Application Publication
(10) Pub. No.: US 2024/0019164 A1
(43) Pub. Date: Jan. 18, 2024

(54) Multifunction panel

(71) Applicant: STE Srl, San Lazzaro di Savena (IT)

(72) Inventors: Federico Serenari, San Lazzaro di Savena (IT); Stefano Serenari, San Lazzaro di Savena (IT)

(21) Appl. No.: 18/252,034

(22) PCT Filed: Nov. 27, 2021
(86) PCT No.: PCT/IB2021/061032

§ 371 Date: May 6, 2023

(30) Foreign Application Priority Data
Dec. 1, 2020 (IT) 102020000029258

(51) Int. Cl. F24F 13/068; F24F 13/24; F24F 13/078; E04F 13/08; B32B 3/26; B32B 3/12; B32B 5/18; B32B 5/02

(52) U.S. Cl. CPC F24F 13/068; F24F 13/24; F24F 13/078; E04F 13/0866; E04F 13/0871; E04F 13/0867; B32B 3/266; B32B 3/12; B32B 5/18; B32B 5/022; F24F 2013/245; E04F 2290/02; E04F 2290/041; B32B 2607/00; B32B 2307/7375; B32B 2307/302; B32B 2307/102; B32B 2307/412; B32B 2307/402; B32B 2266/06; B32B 2266/0278

(57) ABSTRACT

A multifunction panel for use in a building defines an interspace, optionally for the passage of air, and includes a first layer having a plurality of first shaped through-holes of a first predetermined diameter; a second layer having a plurality of cells defining a honeycomb or ribbed structure; a third layer having a plurality of second shaped through-holes of a second predetermined diameter, the first and the second holes being selectively open at the opposite ends of respective cells, so as to create a first configuration of a cell providing for the transit of air between the interspace and the internal environment, or vice versa, when a first hole opens at a first end and of a cell at a second hole opens at a second end of the cell, and further generating a Helmholtz resonator.

### TECHNICAL FIELD OF THE INVENTION

The present invention relates to a multifunction panel. In particular, the present invention relates to a multifunction panel installable in internal environments of buildings, for example on the walls and/or on the ceiling of internal environments, for the improvement of the living conditions thereof.

### TECHNICAL BACKGROUND

The degree of comfort perceived by the occupants of an internal environment mainly depends on the thermal and hygrometric conditions, the air quality, the air speed in the environment, the acoustics, as well as the aesthetics and brightness of the environment itself.

To treat the thermal and hygrometric conditions and the air quality of the internal environment, an optimal solution is an air conditioning system of the aeraulic type which introduces filtered air appropriately thermo-hygrometrically treated and renewed with replacement external air into the internal environment, by means of air diffusers suitable to not create annoying air currents for the occupants.

Furthermore, to improve the acoustics of internal environments, the most commonly used practice is the application of soundproofing panels to the ceiling and/or wall.

In fact, panels can be found on the market, for example also honeycomb panels with soundproofing function, provided with Helmholtz resonators.

However, these acoustic panels do not have any air conditioning function for the environment in which they are installed.

It is clear that the installation of an air conditioning system which requires ventilation panels and the installation of further soundproofing panels to improve the acoustic features of the internal environments has disadvantages, mainly due to the higher total purchase cost and the increase in installation times and costs.

Since aeraulic panels and acoustic panels are required, the total quantity of the panels is given by the sum of the two types of panels, which also require the use of technicians and installers of different specialisations.

Furthermore, with the two types of aeraulic and acoustic panels there is the complication of having to search for sufficient free surfaces in the environment for the application of the aforesaid aeraulic panels and acoustic panels. U.S. Pat. No. 6,602,129 B1 discloses an air diffuser which substantially has a chamber closed by a thin wall with micro-holes, which constitutes the panel which diffuses the air into the environment to be air-conditioned.

The micro-holes are arranged according to a 5 mm side lattice and have a diameter of 0.5 mm so that the section intended for the air flow is therefore less than 1%. A prechamber, connected to an air conditioning source, is placed above the chamber; such a prechamber is connected to the chamber itself through a partition wall by means of a distributor, provided with an air emission surface with a low perforation percentage for the high-speed exit of air.

The air conditioning is introduced into the chamber by means of the distributor which distributes the air inside the chamber, at high speed and with turbulent motion, so that the air which laps the internal surface of the micro-perforated panel, before exiting therefrom, has a high heat exchange coefficient due to the high speed and turbulence.

Each diffuser has a dimensional surface limit due to the shape of the cooling wall provided with micro-holes, made by means of a simple sheet of thin sheet metal, which beyond a given dimensional limit deforms due to its own weight and the thrust of the air introduced upstream, equal to the resistance which the air encounters when passing through the micro-holes.

The consequence is that many diffusers are required for relatively large environments, each provided with its own chamber with internal air distributor and a respective air-conditioning air supply line.

Therefore, there is a complication and an increase in costs for the installation of these panels which must be supplied individually.

Moreover, the diffuser panels of U.S. Pat. No. 6,602,129 B1, in order to function correctly, require being supplied by air with rather high static pressure values, which determines high energy consumption of the fan, due to:
the considerable pressure drops of the internal distributor, which is provided with holes with a low perforation percentage due to the need to have the air introduced into the chamber at high speed;
the turbulent motion inside the chamber, deliberately generated with the introduction of high-speed air as mentioned above, necessary to obtain a high heat exchange coefficient value;
considerable pressure drops due to the passage of air through the micro-perforated sheet towards the environment.

Furthermore, such panels each being supplied with a limited range of air flow rates as:
the maximum flow rate is limited by the features of the distributor inside the chamber and the micro-perforated sheet from which the air exits towards the environment, described above, in fact the aforesaid diffusers, with air flow rates greater than values of the order of about 45 m3/h per m2 of gross diffuser surface, suffer from problems of high noise and an exponential increase in static pressure losses, with consequent unacceptable energy consumption due to the necessary prevalence which the fan must provide;
the minimum flow rate is necessary to maintain the vortex motion required inside the chamber in front of the micro-perforated panel and to preserve the inductive effect of the air exiting the micro-holes towards the environment;

For these reasons, in some cases the maximum air flow rates which the diffusers of U.S. Pat. No. 6,602,129 B1 are capable of introducing into an environment may not be sufficient to meet the needs of the aeraulic system.

In other cases, for example for air conditioning environments with limited thermal demand and therefore reduced air flow rate requirements, the minimum air flow rates introduced would determine a use of a limited number of diffuser panels, which may be insufficient to effectively cover the total surface area of the room for the purpose of completely replacing the exhausted air throughout the environment.

Furthermore, with the diffusers of U.S. Pat. No. 6,602,129 B1, there is no specific soundproofing function envisaged and in any case any soundproofing provided may not be adequate or adaptable to the needs of the environment in which they are installed.

In fact, in the diffusers of U.S. Pat. No. 6,602,129 B1, the micro-holes are all equally in communication with the supply chamber, therefore a Helmholtz resonator is intrinsically constituted characterised by a single frequency peak with greater soundproofing efficiency.

### OBJECTS OF THE INVENTION

It is an object of the present invention to provide a new multifunction panel.

It is another object of the present invention to provide a new multifunction panel which allows to obtain the correct ventilation/air conditioning, also with a radiant component, of the internal environments of buildings, ensuring the optimal control of the air flows, and at the same time improving the acoustic features of such environments.

It is another object of the present invention to provide a new multifunction panel which can be configured according to the required specifications, both aeraulic and acoustic, for the internal environments where it is to be installed.

In this regard, and in order to adapt to the aforesaid required specifications, the multifunction panel according to the present invention can also perform only a soundproofing function with a broad band of soundproofed acoustic frequencies, if it is not connected to a source of air conditioning or air exchange.

It is another object of the present invention to provide a new multifunction panel which ensures safe and reliable operation.

It is another object of the present invention to provide a new multifunction panel which is economically more advantageous with respect to the adoption of separate aeraulic panels and acoustic panels.

It is another object of the present invention to provide a new multifunction panel which is generally advantageous for construction and installation in terms of production times and costs, with respect to known solutions with separate aeraulic panels and acoustic panels and which require many panels of limited dimensions, individually supplied by the air conditioning.

According to an aspect of the invention, a multifunction panel is included according to claim 1.

According to an aspect of the present invention, the multifunction panel, of the type installable in an internal environment of a building, for example on a wall and/or on a ceiling, comprises at least one interspace at least for the transit of air, at least a first layer affected by a distribution of first shaped through-holes, at least a second layer with a honeycomb structure defining a plurality of cells, at least a third layer affected by a distribution of second shaped through-holes. The first layer faces the interspace, the second layer with a honeycomb structure is interposed between the first layer and the third layer, the third layer faces the internal environment, the cells each comprise a first open end facing the first layer and a second open end opposite the first and facing towards the second layer.

The aforementioned first holes and second holes selectively open at the first ends and at the second ends of respective cells, so as to create at least a first configuration of at least one cell adapted at least to constitute a passage for the transit of air between the interspace and the internal environment, or vice versa, when at least a first hole opens at the first end and at least a second hole opens at the second end and to also constitute a Helmholtz resonator.

In a version of the present invention, in addition to the aforementioned first configuration, said first holes and second holes selectively open at the first ends and the second ends of respective cells, so as to obtain at least a second configuration of at least one other cell adapted to constitute at least one Helmholtz resonator when at least a second hole opens only at the second end and none of the first holes open at the first end.

According to another aspect of the invention, a multifunction panel is included according to claim 16.

The dependent claims refer to preferred and advantageous examples of embodiments of the invention.

### BRIEF DESCRIPTION OF THE DRAWINGS

Other features and advantages of the invention will be more evident from the description of some example embodiments of panels according to the present invention, illustrated by way of example in the accompanying drawings in which:

FIG. 1 is a schematic cross-section of a possible embodiment of a multifunction panel according to the present invention;

FIG. 1A is an enlargement of the schematic cross-section of the multifunction panel of FIG. 1;

FIG. 1B is an enlargement of the schematic cross-section of a variant of the multifunction panel of FIG. 1;

FIG. 2 is a schematic cross-section of a possible embodiment of a multifunction panel installed on fixed parts of an internal environment, according to the present invention;

FIG. 2A illustrates an environment in which multifunction panels according to the present invention are installed;

FIGS. 3, 3A, 4-14, 16 and 18 are schematic front views of possible embodiments of a multifunction panel, according to the present invention;

FIG. 3B is an enlargement of the schematic cross-section of the multifunction panel of FIG. 3A;

FIG. 15 is a frequency/absorption coefficient graph related to the embodiment of the multifunction panel of FIG. 14;

FIG. 17 is a frequency/absorption coefficient graph related to the embodiment of the multifunction panel of FIG. 16;

FIG. 18A is a schematic cross-section of the multifunction panel of FIG. 18 according to the line XVIIIB, comprising a fourth soundproofing layer;

FIG. 19 is a frequency/absorption coefficient graph related to the embodiment of the multifunction panel of FIG. 18;

FIG. 20 is a frequency/absorption coefficient graph related to the embodiment of the multifunction panel of FIG. 18A;

FIG. 21 is a schematic section of another possible embodiment of a multifunction panel according to the present invention; and

FIG. 22 is a frequency/absorption coefficient graph related to the embodiment of the multifunction panel of FIG. 21.

In the accompanying drawings, identical parts or components are distinguished by the same reference numerals.

EXEMPLARY EMBODIMENTS OF THE INVENTION

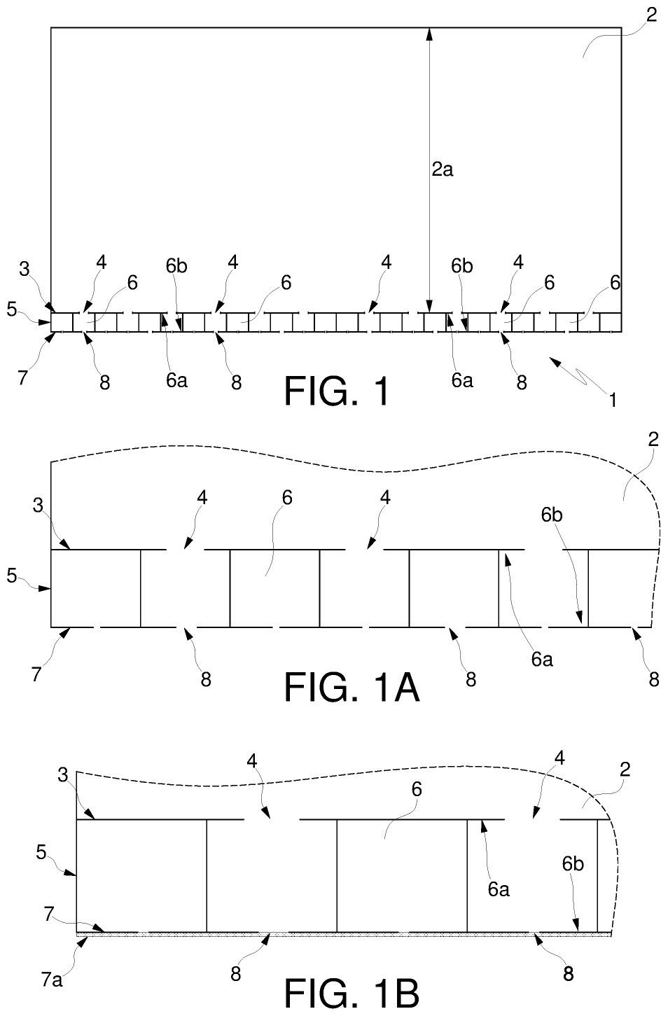

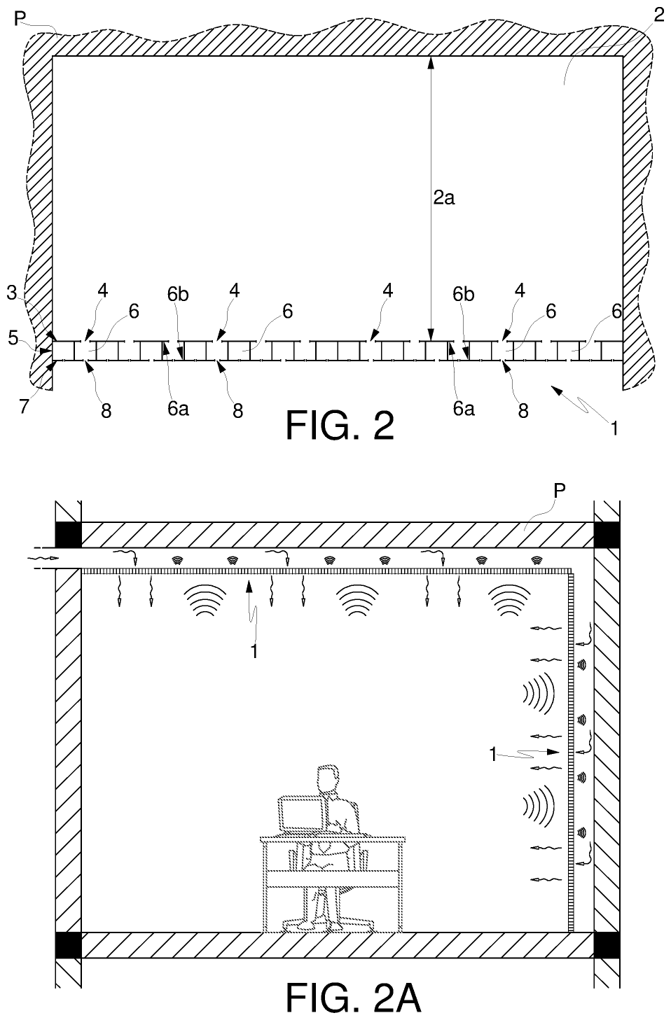

With reference to the accompanying drawings, a multifunction panel, of the type installable in an internal environment of a building, for example on a wall and/or on a ceiling, comprising at least one interspace 2, which has a constant depth 2a as illustrated in FIGS. 1 and 2, or the interspace depth can be differentiated along the surface of the panel, at least a first layer 3 affected by a distribution of first shaped through-holes 4, at least a second layer 5 with a honeycomb, or ribbed, structure, defining a plurality of cells or sectors 6, at least a third layer 7 affected by a distribution of second shaped through-holes 8.

The interspace 2 can be used for the introduction or suction of air or it can be closed, i.e., without being in communication with a source of air conditioning and/or suction air, or air replacement.

In fact, to adapt to the aforesaid required specifications, the multifunction panel according to the present invention can perform even only a soundproofing function with an enlarged band of soundproofed frequencies.

In the following, for the sake of simplicity, only the term cells 6 will be used, indicating both the cells present in the honeycomb structure of the second layer 5, and the sectors present in the ribbed structure of another version of the second layer 5.

The second layer 5, in addition to performing a structural function for the panel 1, performs a compartmentalisation and heat exchange function as will be described in detail later.

The first layer 3 faces the interspace 2, the second layer 5 with a honeycomb or ribbed structure is interposed between the first layer 3 and the third layer 7, the third layer 7 faces the internal environment, the cells or sectors 6 each comprise a first open end 6a facing the first layer 3 and a second open end 6b opposite the first 6a and facing the third layer 7. The aforementioned first holes 4 and second holes 8 open selectively at the first ends 6a and at the second ends 6b of the respective cells 6, so as to create at least a first configuration of at least one cell 6 adapted to at least constitute a passage for the transit of air between the interspace 2 and the internal environment, or vice versa, when at least a first hole 4 opens at the first end 6a and at least a second hole 8 opens at the second end 6b and to also constitute a Helmholtz resonator.

In addition to the aforementioned first configuration, said first holes and second holes can be selectively opened at the first ends and the second ends of respective cells, so as to obtain at least a second configuration of at least another cell 6 adapted to constitute at least one Helmholtz resonator when only at least a second hole 8 opens at the second end 6b and none of the first holes 4 opens at the first end 6a.

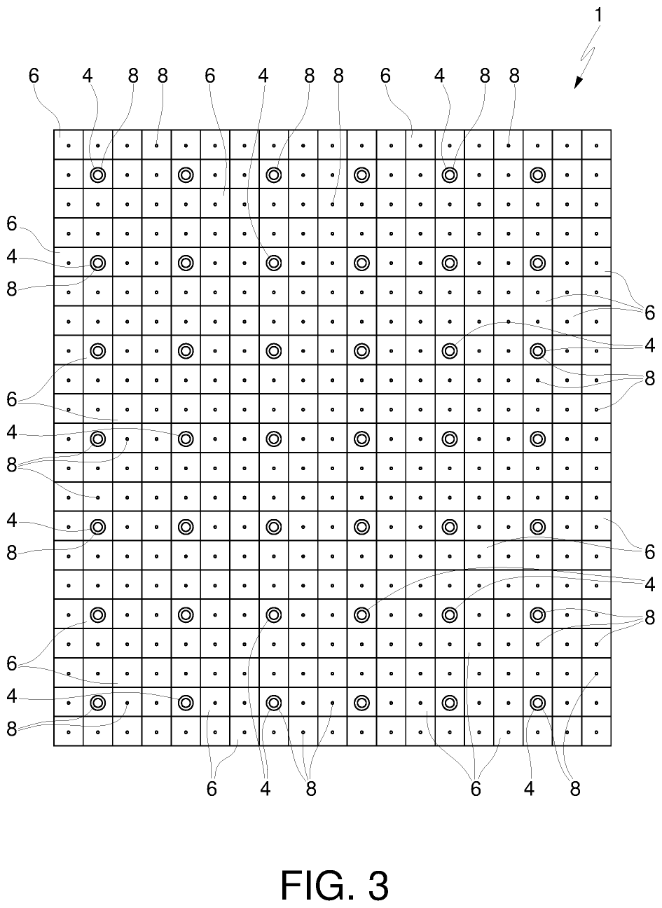

FIGS. 3A, 3B illustrate a variant of the panel 1 according to the present invention. In this variant, the panel 1 is made as a ribbed honeycomb and the cells 6 have a continuous longitudinal extension, therefore a plurality of first holes 4 and second holes 8 open in each cell 6.

Helmholtz resonators are cavities or vessels, of various sizes and shapes, comprising an inlet, called a neck and made for example by a hole, communicating with a resonance chamber; the mass of air contained in the internal chamber constitutes a mechanical system of the mass-spring type: since the air in the neck moves in a narrow space, the air contained in the internal chamber, which constitutes the vibrating mass, must employ a given amount of energy to overcome the resistance to friction. These systems are selective: the sound is absorbed around a specific frequency called resonance. By changing the size of the neck or by changing the volume of the internal chamber it is possible to move the resonance frequency of the system and by inserting porous material into the internal chamber it is possible to enlarge the absorption bandwidth.

A cell 6 in the aforesaid second configuration constitutes the resonance chamber of a Helmholtz resonator, and the respective second hole 8 communicating therewith constitutes the inlet of the Helmholtz resonator.

Even in the case of the first configuration previously described, i.e., a cell 6 which defines a passage for air transit—i.e., a cell 6 placed in communication with its first end 6a with at least a first hole 4 and placed in communication with its second end 6b with at least a second hole 8—the cell 6 in turn defines with the interspace 2 a further Helmholtz resonator: in fact, the cell 6 itself with the at least a first hole 4 and with the at least a second hole 8 define the entrance of a Helmholtz resonator, and the interspace 2 constitutes the resonance chamber of a Helmholtz resonator.

Helmholtz resonators are also defined by cells 6 at the second ends 6b and first ends 6a of which a plurality of second holes 8 and/or first holes 4 respectively open (resonators defined in the latter case together with the interspace 2).

By varying the shape and size of the cells 6, of the first and second holes 4, 8 and of the interspace 2, for example by varying the depth 2a of the interspace 2, Helmholtz resonators of different resonance frequency can be obtained, so as to soundproof different sound frequencies, in particular by increasing the depth 2a the value of the resonance frequency is lowered.

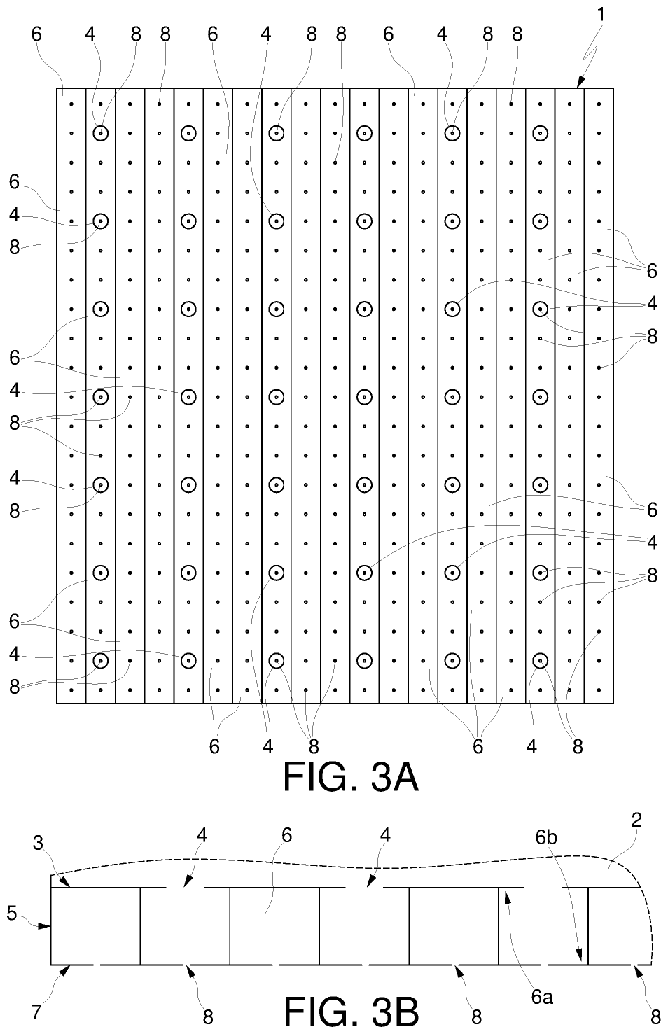

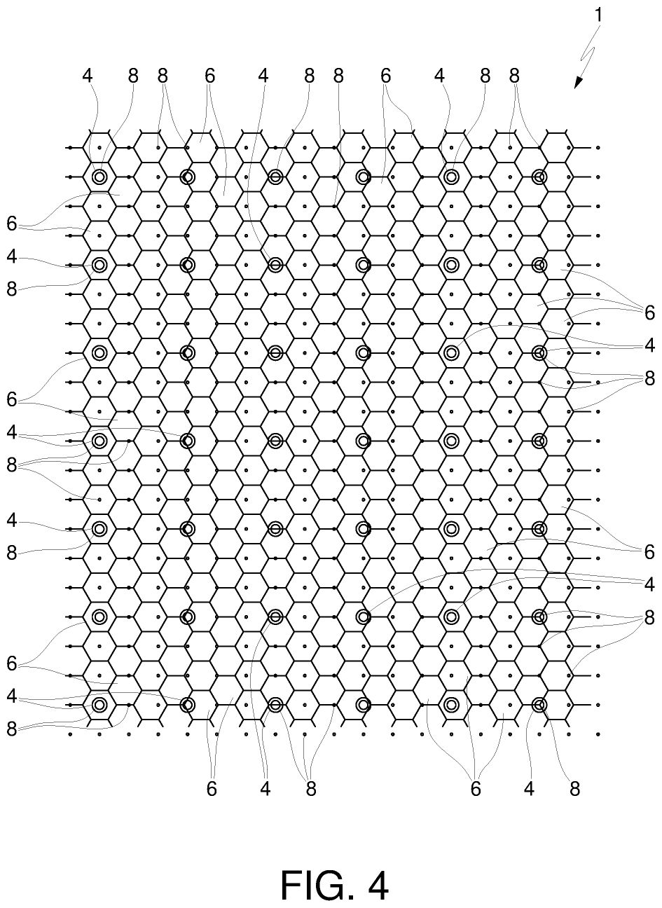

In possible embodiments of the panel 1, at the second end 6b of at least one respective cell 6 of the second layer 5, a plurality of second holes 8 of the third layer 7 can be opened completely and/or partially, as seen for example in FIGS. 4-14, 16 and 18.

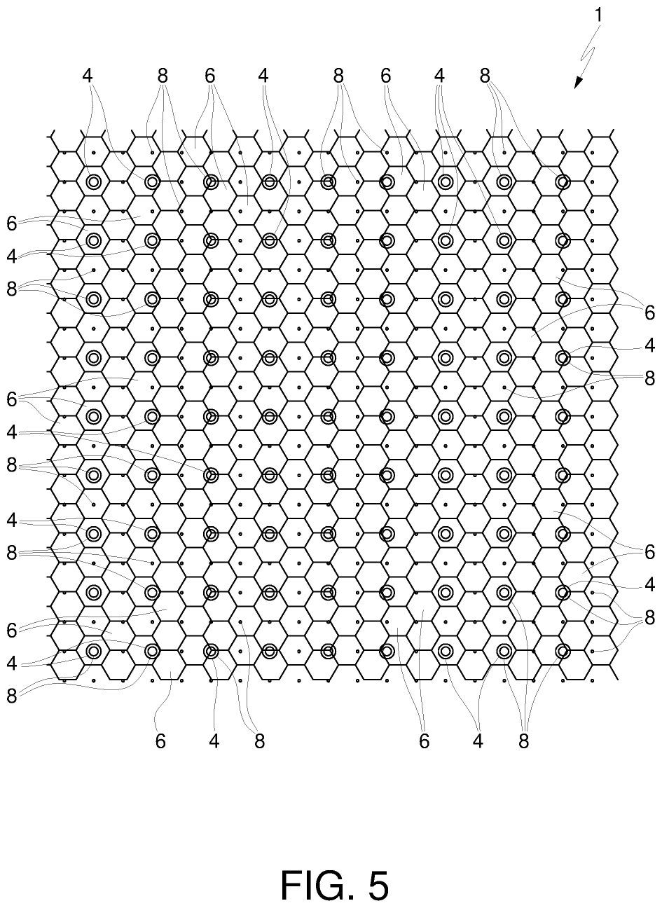

In possible embodiments of the panel 1, at the first end 6a of at least one respective cell 6 of the second layer 5, a plurality of first holes 4 of the first layer 3, as seen for example in FIGS. 6, 9, 10, 11, 12 and 18, can fully and/or partially open.

In possible embodiments of the panel 1, at least a first hole 4 of the first layer 3 can fully and/or partially open at a plurality of first ends 6a of respective cells 6 of the second layer 5, as seen for example in FIGS. 4, 5, 6, 9, 10, 11, 12, 14,18 and 21.

In possible embodiments of the panel 1, at least a second hole 8 of the third layer 7 can fully and/or partially open at a plurality of second ends 6b of respective cells 6 of the second layer 5, as seen for example in FIGS. 4, 5, 6, 7, 8, 9, 10, 11, 12, 14, 18, and 21.

The first holes 4 of the first layer 3, and/or the second holes 8 of the third layer 7, and/or the cells 6 of the second layer 5 and/or the interspace 2 can have variable shape, size and distribution, so as to allow the passage of different predetermined air flows and/or so as to create Helmholtz resonators of different predetermined resonance frequencies.

More in detail, the first through-holes 4 of the first layer 3 can have any suitable shape, for example circular, oval, square, rectangular, polygonal or still another shape.

The cells 6 of the second layer 5 can have any suitable cross-sectional shape, for example, square, rectangular, hexagonal, polygonal, circular, oval, or still another shape, or, as mentioned, the second layer 5 has a ribbed structure.

A passage of the cells 6 is also defined which corresponds to the distance between the centres of the cells themselves—the centre of a cell being the centre of a circle inscribed in the cell—or the distance between the longitudinal axes of the sectors if the second layer 5 has a ribbed structure.

Furthermore, it should be noted that the height of the cells 6 corresponds to the thickness of the second layer 5. The second through-holes 8 of the third layer 7 can have any suitable shape, such as circular, oval, square, rectangular, polygonal, or still another shape.

Furthermore, the first holes 4 of the same first layer 3 can have different shape and/or size from each other (such a solution is not depicted in the figures).

Even the cells 6 of the same second layer 5 can have different cross-section and/or size from each other (such a solution is not depicted in the figures). Also, the second holes 8 of the same third layer 7 can have different shape and/or size from each other, as seen for example in FIGS. 1, 2, 3, 4, 5, 6, 7, 8, 9, 13 and 16.

FIG. 1A illustrates an enlargement of the panel section of FIG. 1, in which it is possible to see, among other things, the greater cross-sectional dimension of the holes 4 with respect to the cross-sectional dimension of the holes 8.

FIG. 1B illustrates a variant of the panel of FIG. 1, in the part facing the environment the panel 1 comprises a fourth coating layer 7a associated with the third layer 7, said fourth layer 7a can be made, for example, of air-permeable fabric or nonwoven fabric (TNT), for example in fibres such as: polyester, polyamide, glass, etc.

The fourth coating layer 7a allows to customise the environment aesthetically and can act as a functional aid since, as it can also be made, for example, with a soundproofing cloth, at the surface part of the layer 7 without holes 8 it helps to reduce the amount of sound reflected towards the environment and at the holes 8 it acts as an addition of porous soundproofing material in the neck—i.e., the hole—of the Helmholtz resonator, having the effect of enlarging the spectrum of absorbable frequencies.

Other versions of the panel 1 (not shown) can perform, at the same time as the aeraulic and acoustic functions already described above, also lighting functions, thus unifying some surfaces already used for the aforesaid functions also using them at the same time for lighting the environments concerned.

This allows, in the event of aeraulic/acoustic needs requiring the use of large surfaces in environments where high brightness values are also necessary, to be able to make the most of the available surfaces without penalising the availability of the necessary spaces for the lighting equipment.

A version of such a type of honeycomb panels could have, for example, the layers 3 and 7 made of transparent, white or coloured sheets permeable to light, provided with through-holes 4 and 8, where envisaged for aeraulic and acoustic purposes, with lamps, or other lighting fixtures, placed above the panel inside the interspace 2 for the supply air, which in this case, therefore, would also serve as a housing for the lighting fixtures.

In the case illustrated in FIGS. 3A, 3B, since the panel 1 is made as a ribbed honeycomb and the cells 6 have a continuous longitudinal extension, it is also possible to introduce the lighting fixtures, such as LED strips or light chains, into the cells 6 with continuous longitudinal extension (not illustrated).

In the latter case, only the third layer 7 can be made with transparent, white or coloured sheets, permeable to light, since the lighting fixtures would be placed inside the cells 6 with continuous longitudinal extension and not inside the interspace 2.

In FIG. 3 a multifunction panel 1 is shown in which the cells 6 have square cross-section, the first holes 4 are circular, they all have the same diameter and each open in a respective cell 6, and the second holes 8 are circular, have different diameters, the second holes 8 with greater diameter each opening in a respective cell 6 coaxially to the corresponding first holes 4.

FIGS. 4, 5 and 6 depict other multifunction panels 1, in each of which the cells 6 have hexagonal cross-section, so as to form a honeycomb structure, the first holes 4 are circular, all have the same diameter and each open in a respective cell 6 or in multiple cells 6, and the second holes 8 are circular, have different diameters, and each open in a respective cell 6 or in multiple cells 6, the second holes 8 with greater diameter being coaxial to corresponding first holes 4. The panels 1 depicted in FIGS. 4, 5 and 6 differ from each other due to the different distribution of the first holes 4 and the second holes 8 in the respective first layer 3 and third layer 7.

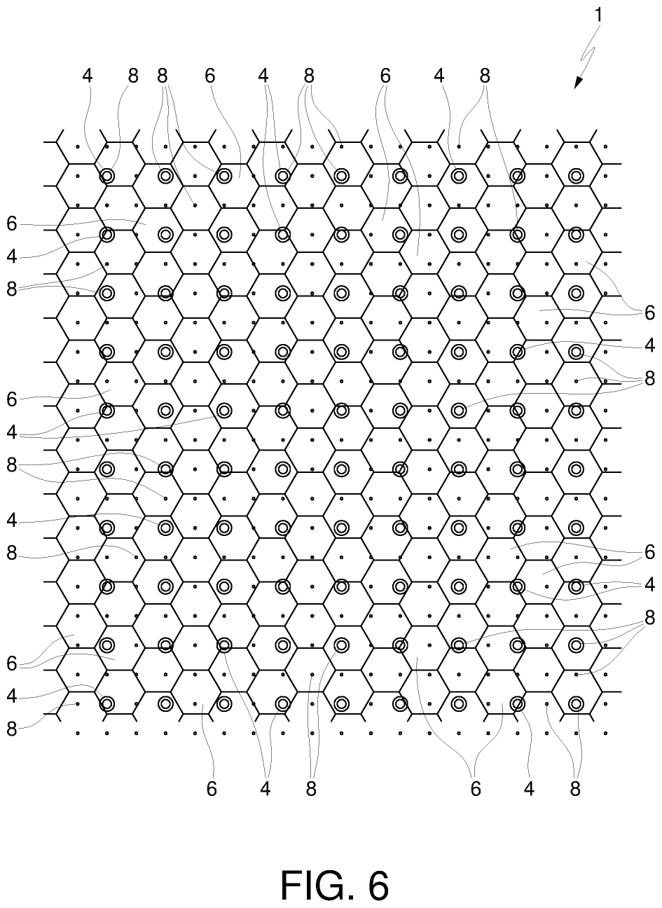

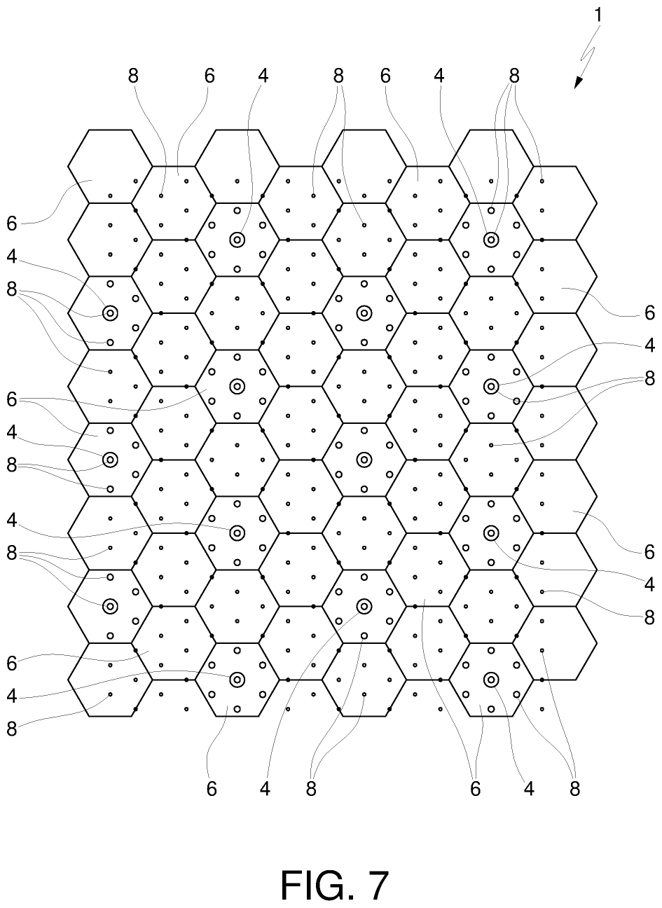

FIGS. 7 and 8 show other multifunction panels 1, in each of which the cells 6 have greater hexagonal cross-section with respect to those of the cells 6 of the examples of FIGS. 4-6, so as to form a honeycomb structure, the first holes 4 are circular, all have the same diameter and each open coaxially in a respective cell 6, and the second holes 8 are circular, have different diameters, and open in groups each in a respective cell 6 or in multiple cells 6.

It should be noted that, in the embodiments of FIGS. 7 and 8, the large cells 6 (in the second layer 5) allow to reduce the number of second holes 8 (of the third layer 7) which are possibly obstructed by the adhesive which is used to connect the second layer 5 to the third layer 7.

Furthermore, the large cells 6 also allow to increase the number of second holes 8 present in each cell 6. In FIG. 7, in each cell 6 at the first end 6a of which a first hole 4 opens, at the second end 6b a respective group of second holes 8 all of the same diameter (greater with respect to that of the other second holes 8 which open in cells 6 not communicating with first holes 4), of which one is arranged coaxial with respect to the corresponding first hole 4, and the others are distributed in a crown around it; in FIG. 8, in each cell 6 at the first end 6a of which a first hole 4 opens, at the second end 6b a respective group of second holes 8 opens of which only one is of greater diameter and is arranged coaxial with respect to the corresponding first hole 4, and the others are distributed in a crown around it.

The presence of some second holes 8 of greater diameter allows a dragging effect of the air exiting such holes 8, so as to send it farther away from the installed panel 1.

Furthermore, the presence of a few second holes 8 of greater diameter also allows to obtain a greater movement and mixing of the air in the environment and promotes proper ventilation and air conditioning even in internal environments of high cubic capacity.

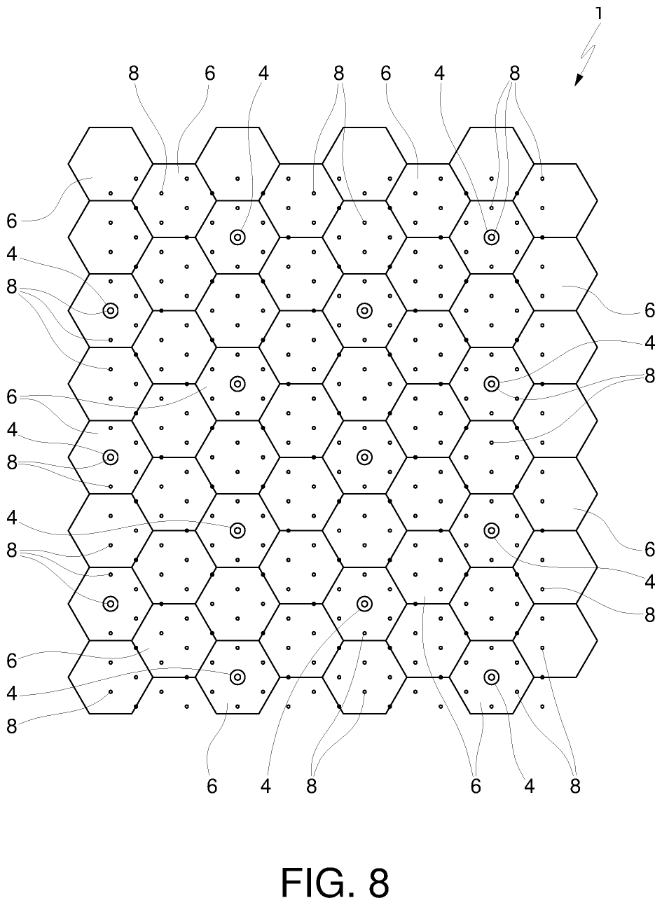

FIG. 9 depicts another multifunction panel 1, in which the cells 6 have hexagonal cross-section (such as that of the cells 6 of FIGS. 4-6), so as to form a honeycomb structure, the first holes 4 are square, all have the same side and each open in several cells 6, and the second holes 8 are circular, have different diameters, and each open in a respective cell 6 or in multiple cells 6.

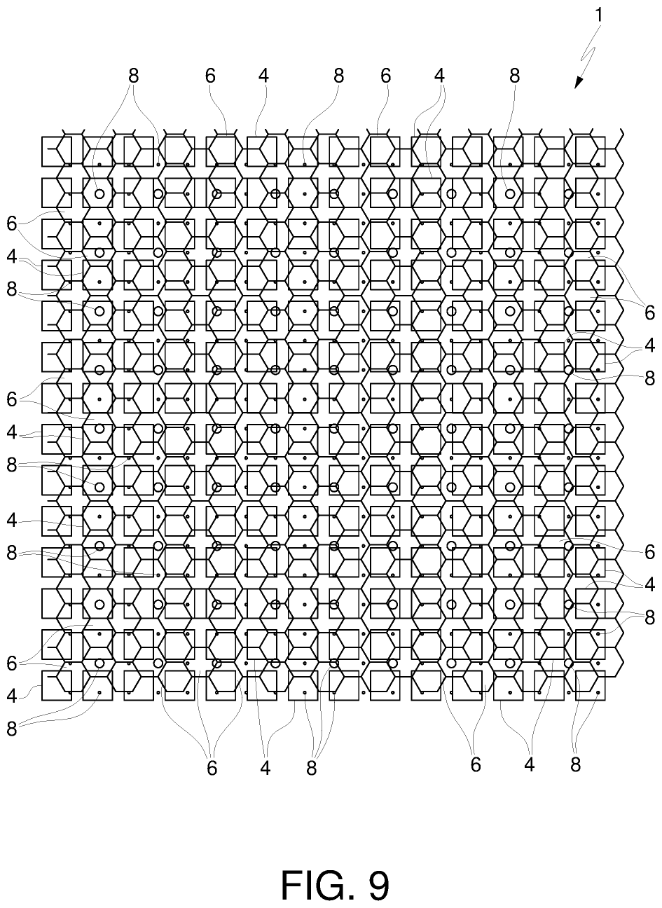

FIG. 10 depicts another multifunction panel 1, in which the cells 6 have hexagonal cross-section (such as that of the cells 6 of FIGS. 4-6), so as to form a honeycomb structure, the first holes 4 are square, all have the same side and each open in several cells 6, and the second holes 8 are circular, all have the same diameter, and each open in a respective cell 6 or in multiple cells 6.

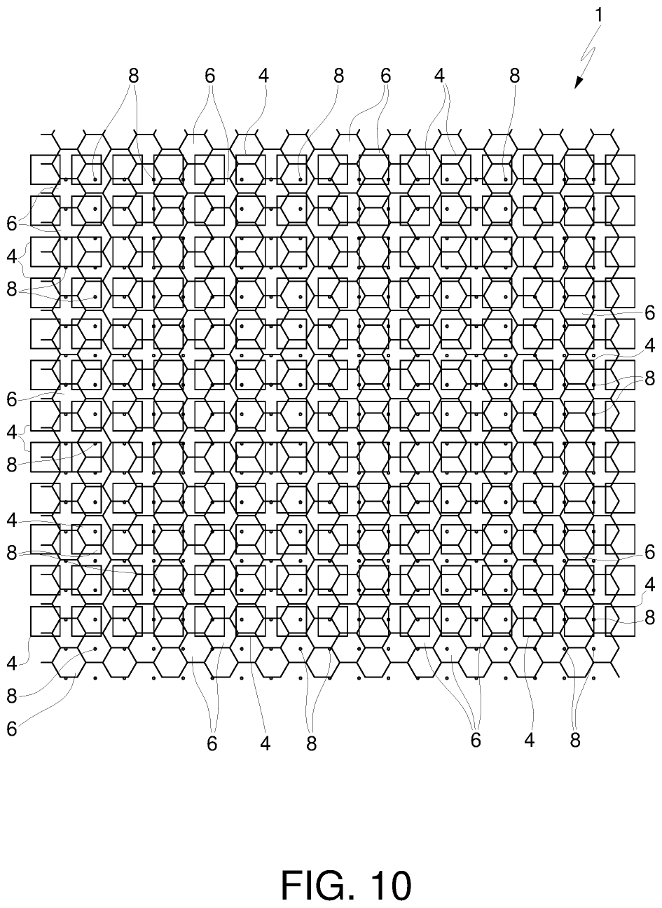

FIG. 11 depicts another multifunction panel 1, in which the cells 6 have greater hexagonal cross-section with respect to those of the cells 6 of the examples of FIGS. 9 and 10 (and like that of the cells 6 of FIGS. 7 and 8), so as to form a honeycomb structure, the first holes 4 are square, all have the same side, each open in several cells 6, and the second holes 8 are circular, all have the same diameter, and each open in a respective cell 6 or in multiple cells 6.

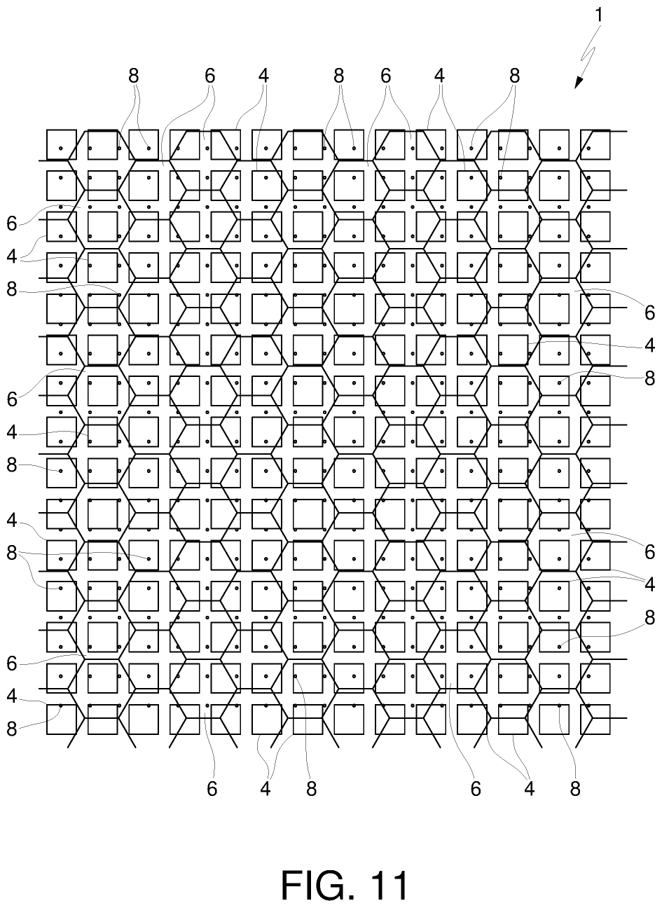

FIG. 12 depicts another multifunction panel 1, in which the cells 6 have a greater hexagonal cross-section with respect to those of the cells 6 of the examples of FIGS. 9 and 10 (and like that of the cells 6 of FIGS. 7 and 8), so as to form a honeycomb structure.

The first holes 4 are square, all have the same side, each open in multiple cells 6, and the second holes 8 are circular, all have the same diameter and a greater pitch with respect to that of the second holes 8 of the example of FIG. 11, and each open in a respective cell 6 or in multiple cells 6.

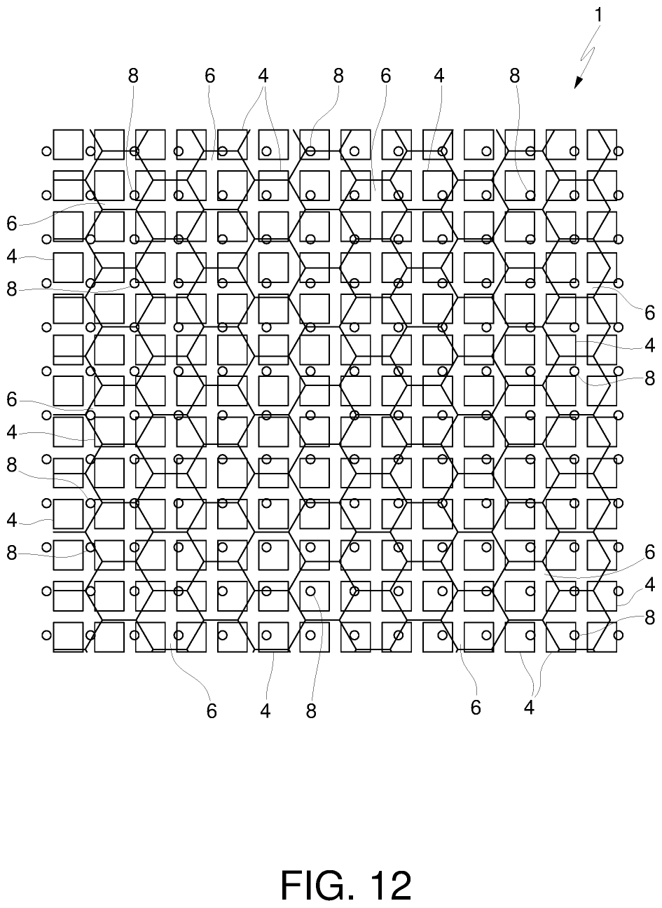

FIG. 13 depicts another multifunction panel 1, in which the cells 6 have circular cross-section, the first holes 4 are circular and each open coaxially in a respective cell 6, and the second holes 8 are circular and have different diameters.

The passage of the second holes 8 with smaller diameter and the passage of the holes 8 with larger diameter are selected according to the aeraulic needs of the environment with which they are in communication, and are repeated uniformly throughout the panel surface.

In the embodiment of FIG. 13, the size and relative position of the cells 6 with respect to the second holes 8, determines a configuration in the panel 1 in which the second holes 8 with a smaller diameter open in groups of four, arranged in a crown, in a respective cell 6, and the second holes 8 with a larger diameter open only in some respective cells 6 coaxially to the corresponding first holes 4.

With different pitches of the second holes 8 and different sizes of the cells 6, different configurations are also possible.

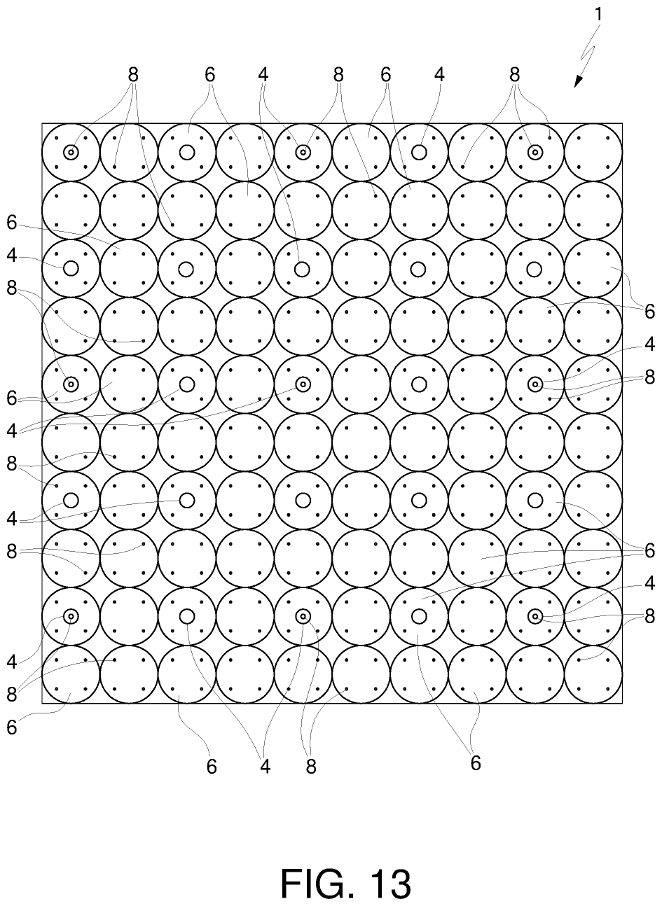

FIG. 14 depicts another multifunction panel 1 which, in a practical example, can be used in tertiary environments, such as offices, and suitable for a movement of air of about 4÷6 vol/h in a room of about 50 m² and 2.8 m in height.

In such a solution, the cells 6 have hexagonal cross-section and having apothem for example of 12.5 mm, the first holes 4 are circular and for example 5 mm in diameter, the second holes 8 are circular and for example all 0.8 mm in diameter. The thickness of the second layer 5 is for example 40 mm, that of the interspace 2 is 160 mm. The first holes 4 each open in a respective cell 6, or in multiple cells 6, so that the ratio between the cells communicating with the interspace 2 (so as to constitute a passage for air) and those not communicating with the interspace 2 is about the order of 40%-50%; the first holes 4 are for example distributed at 90° with 40 mm pitch from each other.

A plurality of second holes 8 open in each cell 6 according to a predetermined distribution adapted to distribute the air uniformly in the environment, and for example the second holes 8 are distributed at 60° with 10 mm pitch from one another.

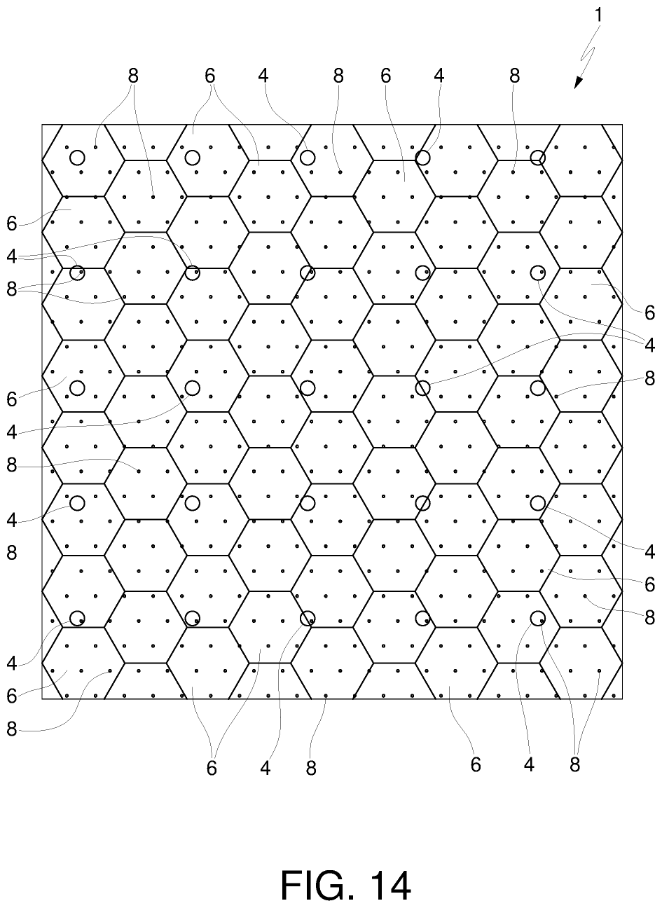

FIG. 15 depicts a frequency/absorption coefficient graph in which the trend of the absorption coefficient α is indicated as a function of the frequency F relative to the multifunction panel 1 of FIG. 14 now described: the curve depicted in a continuous line indicates the trend of the absorption coefficient α of the cells 6 placed in communication with both the interspace 2 and the internal environment; the curve depicted in a dashed line indicates the trend of the absorption coefficient α of the cells 6 placed in communication with the internal environment only, i.e., the cells which are not in communication with the interspace 2.

As reported in various scientific publications, acoustic curves have a cumulative effect, therefore, a frequency range of 170÷600 Hz can probably be assumed in which the panel 1 has a resulting absorption coefficient α>80%.

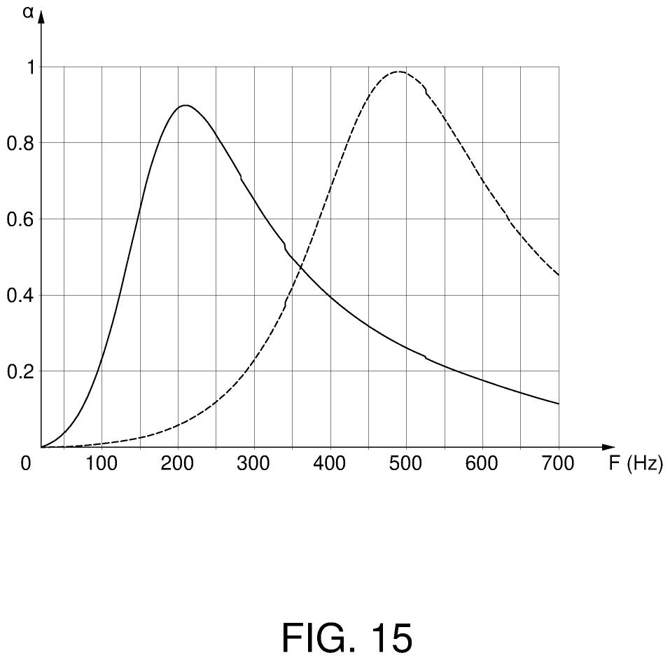

FIG. 16 depicts another multifunction panel 1, which can still be used in tertiary environments, such as offices like the one previously described in the example of FIG. 14, in which the cells 6 have a square cross-section having a side of, for example, 20 mm, the first holes 4 are circular and, for example, 5 mm in diameter, the second holes 8 are circular with a different diameter and, for example, 0.7 mm in diameter and 1.5 mm in diameter. The thickness of the second layer 5 is for example 40 mm, that of the interspace 2 is 160 mm. The first holes 4 are distributed, for example, at 90° with a pitch of 40 mm from one another. The second larger diameter holes 8 open in respective cells 6 coaxially with the corresponding first holes 4, and due to their greater diameter allow a greater inductive effect of the panel 1; for example, the second larger diameter holes 8 are distributed at 90° with a pitch of 80 mm from one another.

The second holes 8 with a smaller diameter open in groups of four at the second end 6b of each respective cell 6, and for example the second holes 8 with a smaller diameter are distributed at 90° with a pitch of 10 mm from one another.

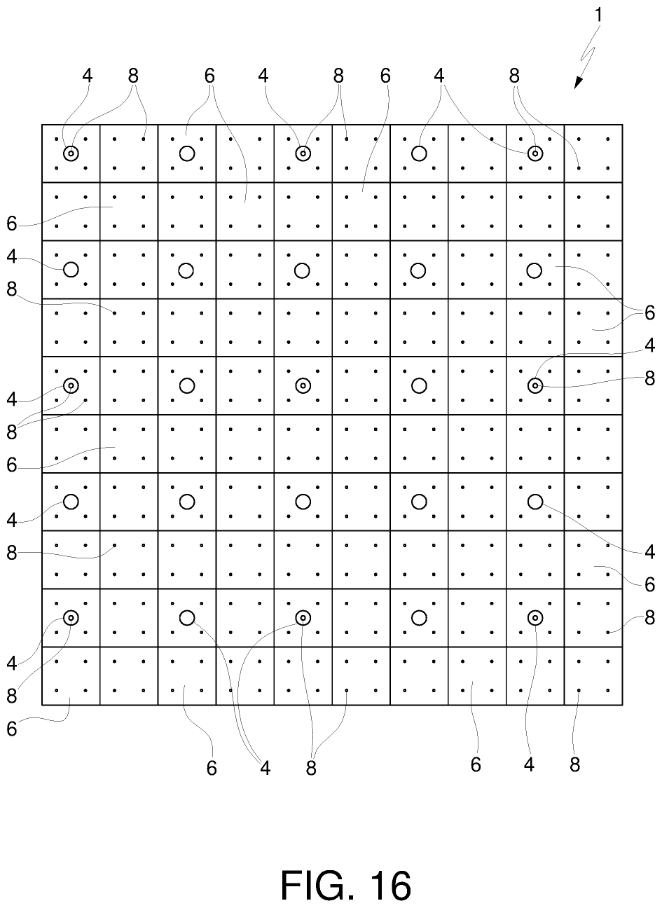

FIG. 17 depicts a frequency/absorption coefficient graph in which the trend of the absorption coefficient α is indicated as a function of the frequency F obtained by the multifunction panel 1 of FIG. 16 now described: the curve depicted in a continuous line indicates the trend of the absorption coefficient α of the cells 6 placed in communication with both the interspace 2 and the internal environment; the curve depicted in a dashed line indicates the trend of the absorption coefficient α of the cells 6 placed in communication with the internal environment only.

As mentioned above, the curves in the graph have a cumulative effect; therefore, a frequency range of 150÷500 Hz in which the panel 1 has an excellent absorption coefficient α>90% can probably be assumed.

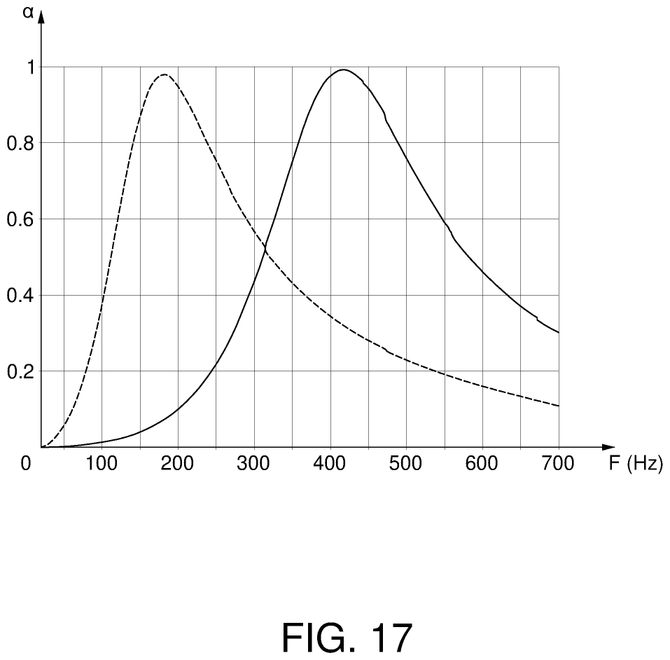

FIG. 18 depicts another multifunction panel 1, usable in environments, for example of the tertiary or industrial type, with high thermal loads and/or ventilation needs, which therefore require greater air flow rates, for example 100÷220 m³/h per m² of panel 1.

The thickness of the second layer 5 is for example 40 mm, that of the interspace 2 is 160 mm. In particular, the first layer 3 consists of a perforated grid with first square holes 4 having a side of, for example, 10 mm, and the cells 6 have hexagonal cross-section having apothem of, for example, 10 mm: the first holes 4 are distributed so that the perforated surface of the first layer 3 constitutes more than 44% of the total surface of said first layer 3, therefore the cells 6 are all placed in communication with the interspace 2, all constituting passages for air in the internal environment, in order to ensure the required flow rates.

The second holes 8 are circular with different diameters and, for example, the second smaller holes 8 are 1 mm in diameter and are distributed at 90° with a 7 mm pitch from one another, and the second larger holes 8 are 2 mm in diameter and are distributed at 90° with a 28 mm pitch from one another. The second holes 8 open in groups at the second end 6b of each respective cell 6.

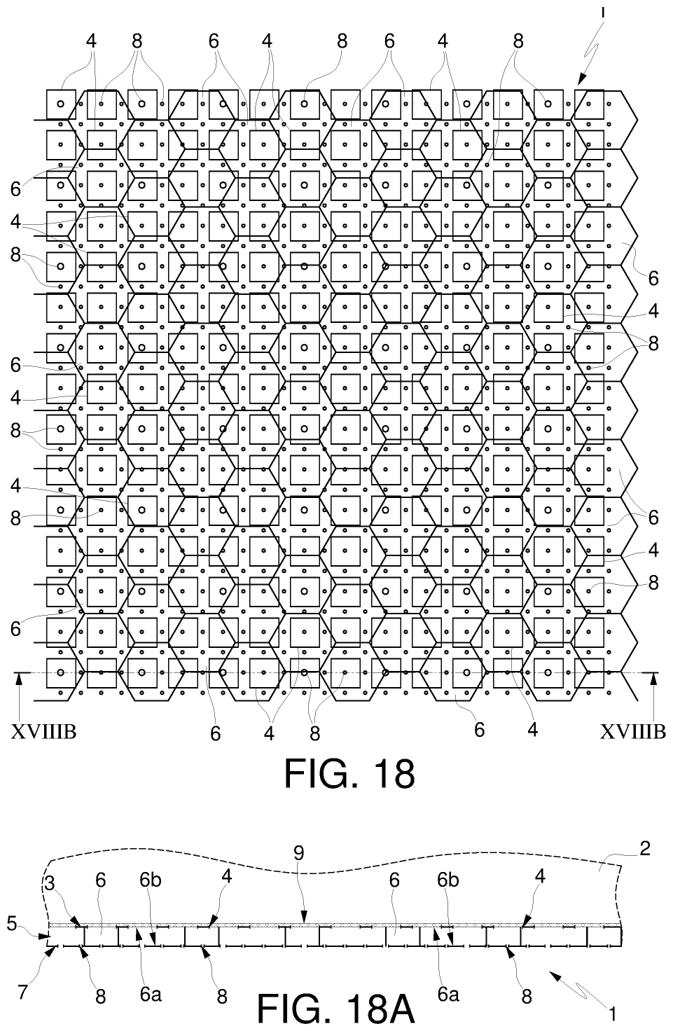

FIG. 19 depicts the frequency/absorption coefficient graph in which the trend of the absorption coefficient α is indicated as a function of the frequency F obtained from the multifunction panel 1 of FIG. 18 now described: the curve depicted in a continuous line indicates the trend of the absorption coefficient α of the cells 6 placed in communication with both the interspace 2 and with the internal environment through the second holes 8 with a greater diameter of 2 mm; the curve depicted in a dashed line indicates the trend of the absorption coefficient α of the cells 6 placed in communication with both the interspace 2 and with the internal environment through the second holes 8 with a smaller diameter of 1 mm.

Also in this case, the curves in the graph have a cumulative effect, therefore a frequency range of 150÷300 Hz in which the panel 1 has a resulting absorption coefficient >65% can likely be assumed.

In this embodiment, it must be noted that all the cells 6 are placed in communication with the interspace 2 so that the different absorption frequency of the holes 8 is due only to the different diameter of the small holes (1 mm) and the large holes (2 mm). Furthermore, since the thickness of the second layer 5 does not affect the acoustic absorption, the second layer 5 can have any thickness and, in particular, instead of being 40 mm, can also be 20 mm because it is sufficient to ensure a structural support of the panel 1 itself.

FIG. 18A depicts a schematic section of the multifunction panel 1 of FIG. 18 further comprising a fifth soundproofing layer 9. In particular, the fifth layer 9 is made of porous soundproofing material, e.g., a flexible open-cell polyurethane resin material of thickness of about 1÷3 cm and density of about 25 kg/m3.

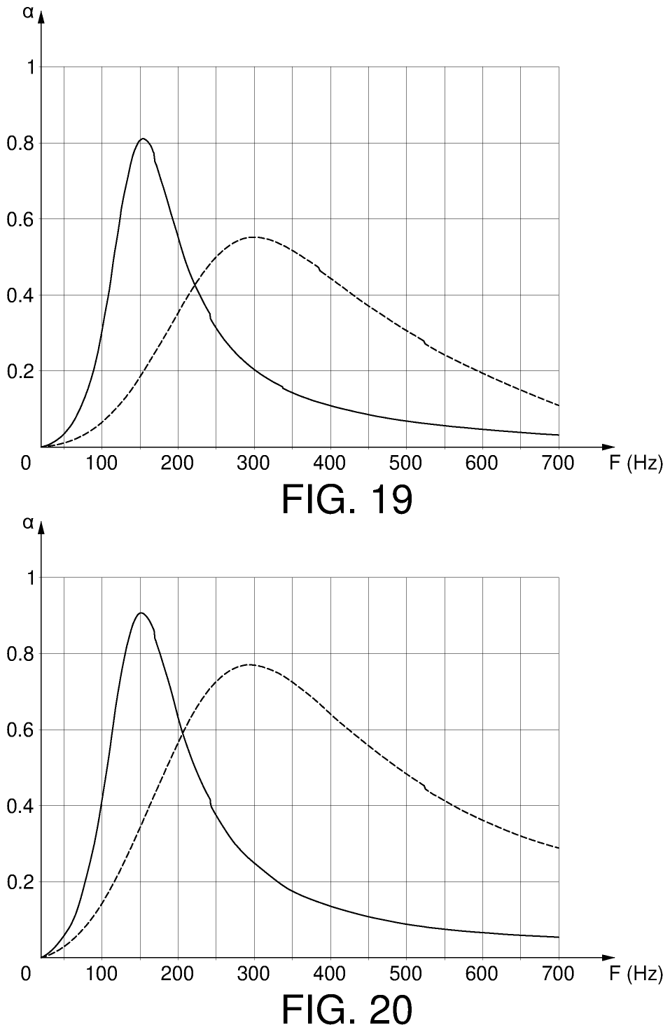

The fifth layer 9 is associated, inside the interspace 2, with the first layer 3, and allows to improve the acoustic absorption, as shown in FIG. 20, i.e., the frequency/absorption coefficient graph, in which the trend of the absorption coefficient α as a function of the frequency F obtained from the multifunction panel 1 of FIG. 18A now described is indicated: the curve depicted in a continuous line indicates the trend of the absorption coefficient α of the cells 6 placed in communication with both the interspace 2 and the internal environment through the second holes 8 with a greater diameter of 2 mm; the curve depicted in a dashed line indicates the trend of the absorption coefficient α of the cells 6 placed in communication with both the interspace 2 and the internal environment through the second holes 8 with a smaller diameter of 1 mm.

As reported for the other cases, the curves in the graph have a cumulative effect, therefore, a frequency range of 120÷400 Hz can likely be assumed in which the panel 1 has a resulting absorption coefficient α>80%, in which for a narrower range of 150÷300 Hz the absorption coefficient α is >85%.

In the examples described above, the graphs related to the absorption coefficients related to the two different Helmholtz resonators present in the panels have been reported.

However, as mentioned above, the curves in the graph have a cumulative effect, therefore, the overall absorption effect is greater than the individual absorption curves of the two Helmholtz resonators.

As already stated, the holes 8 present on the layer 7 can also have different sizes from one another, the same also applies for the holes 4 on the layer 3. In this case, since each different perforation feature corresponds to a relative acoustic absorption curve, the field of sound frequencies which can be acoustically absorbed can be further enlarged with more frequency peaks corresponding to the different dimensions of the holes 4, 8 (solutions not depicted in the graphs of the figures).

In the examples described above, in each panel 1 the respective first holes 4 have larger dimensions with respect to the second holes 8. However, in further embodiments, the first holes 4 can have dimensions equal to or smaller than those of the second holes 8.

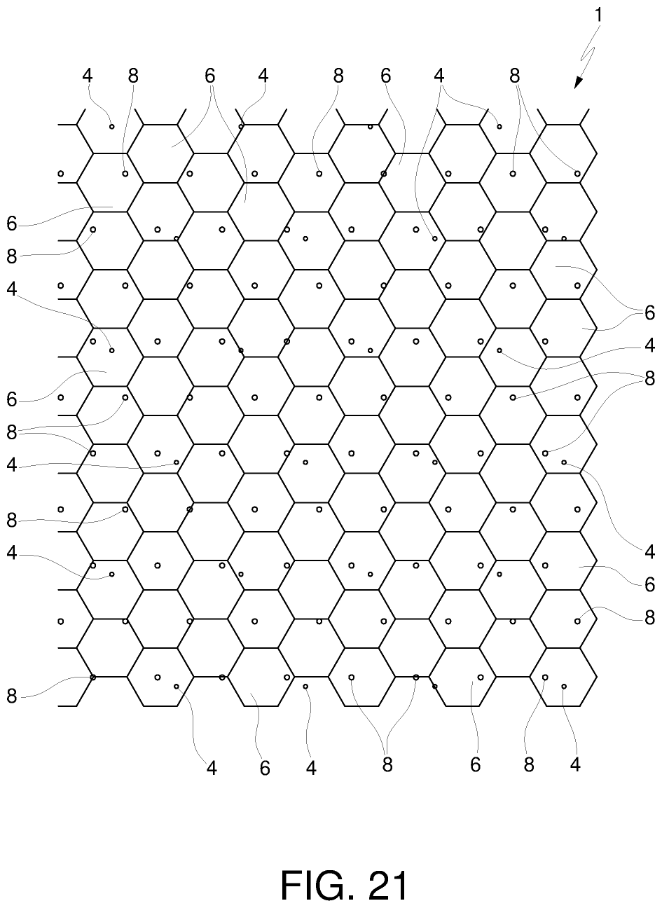

FIG. 21 depicts another multifunction panel 1, which can be used, for example, in environments which do not require a high air flow rate per unit area of the panels, as they have a large surface area, in the ceiling and/or in the walls, for the application of the panels and at the same time require considerable acoustic attenuation and even low frequency bands.

In the specific case of FIG. 21, the first holes 4 of the first layer 3 have a diameter of 0.6 mm and a pitch of 20 mm, the second holes 8 of the third layer 7 have a diameter of 0.8 mm and a pitch of 10 mm, while the second layer 5 has a honeycomb structure with a distance of 9 mm between the hexagonal ends of the honeycomb structure, distance corresponding to the diameter of the circle circumscribed to the hexagon.

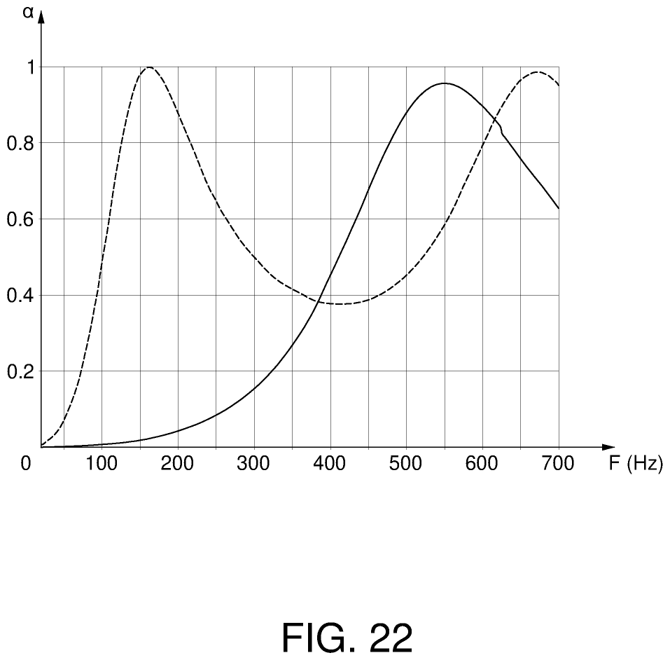

The perforation of the first layer 3 facing the interspace 2 is therefore about 0.1% with respect to the surface of the layer 3, this perforation surface percentage value corresponds to the minimum value, according to the present invention, to have an air flow rate sufficient for the air conditioning of an environment characterised by silent acoustic requirements and with thermal loads which require minimal, but necessary, ventilation and air movement throughout the room. The second holes 8 of the third layer 7, i.e., the part facing the environment, are instead optimised for the purpose of acoustic absorption as can be seen in the relative acoustic graph of FIG. 22.

In the aforesaid frequency/absorption coefficient graph of FIG. 22, the curve depicted in dashed continuous line indicates the trend of the absorption coefficient α of the cells 6 placed in communication with the internal environment only; the curve depicted in dashed line indicates the trend of the absorption coefficient α of the cells 6 placed in communication with both the interspace 2 and the internal environment.

It can be observed that the cells 6 placed in communication with the internal environment only allow a very efficient acoustic absorption at low frequencies (around 160 Hz), while the cells 6 placed in communication with both the interspace 2 and the internal environment still have very efficient acoustic absorption at higher frequencies (around 550 Hz).

As in the previous cases, the graph of FIG. 22 shows the curves related to the two types of Helmholtz resonators present in the panel of FIG. 21.

The curves in the graph have a cumulative effect, therefore the overall absorption effect of the above panel is greater than the individual absorption curves of the two Helmholtz resonators.

It should also be noted that, due to the relative dimensions of the cells 6 and the perforation pitch in the third layer 7, some cells 6 of the panel of FIG. 21 are not in communication with the environment, and not even with the interspace 2, in which case the cells 6 have a structural support function of the panel itself.

In fact, unlike other known solutions, an important feature of the present invention is that the panels 1 with a honeycomb structure are capable of supporting themselves independently even at large dimensions.

The multifunction panels 1 now described, as non-limiting examples, allow sound waves to be absorbed at different wave frequencies, while ensuring optimal ventilation/air conditioning of the internal environments. Many other combinations and variations are of course possible, all falling within the inventive concept.

The above examples show that, in order to satisfy the aeraulic and acoustic needs of the most diverse types of environments, it is necessary to allow a wide range of air flow rates related to the aeraulic system.

For each situation, or type of environment, the panels 1 according to the present invention have the dimension of the first holes 4, and the relative perforation percentage with respect to the surface of the first layer 3 on which they are located, selected so that the number of cells 6 not involved in the aeraulic function (i.e., the cells 6 closed towards the first layer 3) can perform a soundproofing function suitable for the needs of the environment in which the panels 1 are installed.

It should be noted that the cells 6 not involved in the aeraulic function result from the positioning difference of the first holes 4 in the first layer 3 and the second holes 8 of the third layer 7. Therefore, the cells 6 not involved in the aeraulic function have the second holes 8 of the third layer 7 in communication only with the environment.

Any cells 6 which remain totally inactive from an aeraulic and acoustic point of view, i.e., the cells 6 closed towards both the interspace 2 and towards the internal environment, normally only perform a structural function for the panel.

An attempt is made to avoid this last condition of complete closure for the cells 6, except in special cases, such as the one depicted in FIG. 21, already disclosed above.

From the calculations performed and experimental tests carried out, it has been found that in order to achieve the desired effects in the various areas of application of the panel according to the present invention, the perforation percentages and the passage sections of the first holes 4 must be chosen in the following intervals:
the ratio, expressed as a percentage, between the total surface of the first holes 4 and the total surface of the first layer 3 is between 0.1% and 73%;
the diameter of the first holes 4 is between 0.4 mm and 20 mm, or they are made with areas equivalent to the aforesaid diameter values if the holes have shapes other than circles.

It has been verified that the minimum perforation percentage of 0.1% for the first holes 4 is due to the fact that, in any real case of applicability of the present invention, below the percentage of 0.1% the perforation becomes insufficient for the passage of air to/from the interspace 2.

Furthermore, the number of cells 6 in communication with the interspace 2 excessively decreases, and the absorbed sound frequency spectrum is mainly limited to that related to the frequencies of the closed cells 6 towards the first layer 3, i.e., there is substantially only one acoustic absorption peak related to the cells 6 provided with second holes 8 in communication only with the environment.

With regard to the maximum value of the perforation percentage of 73%, this is a practical limit due to the possibility of producing said first layer 3 and the structural need of the same first layer 3 for coupling with the second honeycomb layer 5. As the perforation percentage of the first layer 3 and the size of the pitch of the cells 6 increases, the cases in which all the cells 6 are in communication towards the interspace 2 can be reached.

Regarding the diameter dimensions of the first holes 4, the minimum value of the diameter was chosen under the aeraulic aspect for the need to limit the pressure drops and the noise generated by the passage of air, while under the acoustic aspect the minimum value of the diameter is due to the need to not overly obstruct the passage of the sound wave towards the interspace 2 which constitutes the resonance chamber of the Helmholtz resonator.

The maximum value of the diameter size of the first holes 4 is a practical limit given by the structural need thereof for coupling with the second layer 5.

As for the second layer 5, the thickness dimension, corresponding to the height of the cells 6, is in the range of 5 mm to 100 mm, the cells 6 have the pitch of 5 mm to 40 mm, while the shape of the cells 6 can be: honeycomb, square, rectangular, quadrangular, circular, ribbed, etc.

The minimum thickness value of 5 mm of the second layer 5 can be applied to obtain self-support in small panels, verifying the compatibility of the features for the necessary sound absorption.

The maximum thickness value of the second layer 5 is indicated for the self-support of panels of very large dimensions and constitutes a practical limit to reduce the overall dimensions and weight of the panel, as well as a limit to define an adequate size of the Helmholtz cells: a greater thickness would lower the resonance frequency of the cells having holes 8 in communication only with the environment, giving rise to a resonance peak with a frequency near that of the open cells also towards the interspace 2.

With regard to the pitch of the cells 6, the minimum value of 5 mm is used to avoid, in the case of very spaced holes 4 and 8, too many cells 6 forming without openings either towards the layer 3 or towards the layer 7; the maximum value of the pitch of the cells 6 of 40 mm is due to structural needs and production difficulties of the second layer 5.

Considering the third layer 7 and the second holes 8, i.e., the side of the panel 1 facing the environment, it should be noted that there can be two types of second holes 8:
second holes 8 which, by means of the cells 6 and the first holes 4, are in communication with the interspace 2 and therefore perform both aeraulic and acoustic functions, these second holes 8 can therefore be called aeraulic-acoustic type holes;
second holes 8 which are in communication only with the cells 6 without first holes 4, and which therefore are not in communication with the interspace 2, these second holes 8 only perform soundproofing functions (in combination with the cells 6), these second holes 8 can therefore be called exclusively acoustic type holes.

In the borderline cases of environments for which very high air flow rates are required, such as in the case of FIG. 18, the second holes 8 can also all be of the aeraulic-acoustic type.

The ratio, expressed as a percentage, between the overall surface of the second holes 8 and the overall surface of the third layer 7 is in a range between 0.1% and 20%, and preferably between 0.4% and 12%.

The ratio, expressed as a percentage, between the overall surface of the second, exclusively acoustic holes 8, and the overall surface of the third layer 7, is in a range between 0.1% and 4%, and preferably between 0.4% and 3.5%.

Such values of perforation percentages were obtained by performing acoustic simulations for the Helmholtz resonators of cells 6 provided with second holes 8 of exclusively acoustic type. For such cells 6 it has been noted that in order to obtain resonance peaks in the frequencies of interest, chosen between 100 Hz and 800 Hz, which do not overlap with the typical resonance peaks reached by the cells 6 provided with second aeraulic-acoustic holes 8, the above-mentioned range of perforation percentage between 0.4% and 3.5% is optimal, and in limited cases the perforation percentage can be wider: between 0.1% and 4%. As regards the minimum limit value of 0.1%, below this value the perforation percentage of the second holes 8 of exclusively acoustic type would be so rare as to affect a few cells 6; the resonance frequency would therefore be low and tending to coincide with that of the cells 6 provided with second aeraulic-acoustic holes 8.

With regard to the maximum limit value of 4%, above this value the perforation percentage of the second holes 8 of exclusively acoustic type is such as to move the resonance peak towards higher frequencies and outside the range of interest; moreover, the greater distance between the peaks of the exclusively soundproofing cells 6 and the aeraulic-acoustic cells 6 would leave an overly wide central frequency range uncovered, and therefore without adequate soundproofing.

With regard to the second aeraulic-acoustic type holes 8, the minimum overall surface area of 0.1% (expressed as a percentage of the overall surface area of the third layer 7) is due to the fact that the surface area for the passage of air also becomes insufficient for very low specific air flow rates related to environments with thermal loads and requires minimal ventilation and air movement.

From the acoustic point of view, below 0.1% of perforation, the resulting resonance frequency is less than the frequency of interest and the acoustic absorption coefficient decreases rapidly as well.

For the second aeraulic-acoustic type holes 8, the maximum total surface area of 20% (always expressed as a percentage ratio with respect to the total surface area of the third layer 7) is due to the fact that, in some cases, depending on the perforation features of the first layer 3 and the air inlet temperature in the environment, a perforation surface area greater than the maximum limit value 20% would determine an output speed from the second holes 8 which is not sufficient to obtain an effective mixing of the air conditioning air with the ambient air.

Therefore, an overly large perforation percentage value of the second aeraulic-acoustic holes 8 would lead to inadequate ventilation and/or temperature uniformity of the environment.

Finally, it should be noted that, with regard to the second aeraulic-acoustic holes 8, the overall surface, expressed as a percentage ratio with respect to the overall surface of the third layer 7, is complementary (with respect to the overall surface of the second holes 8 of both types) to that of the second holes 8 of exclusively acoustic type.

The diameter of the second holes 8 is between 0.1 mm and 20 mm, or they are made with areas equivalent to the aforementioned diameter values if the holes have shapes other than circles.

With regard to the dimensional range of the diameter of the second holes 8, or the equivalent perforation surface in the case of non-circular holes, the following should be considered.

The indicated lower limit value of 0.1 mm, in addition to being a practical limit given the difficulty in producing holes smaller than such a value, as regards the acoustic aspect is due to the need not to overly obstruct the passage of the sound wave towards the resonance chambers, while in the aeraulic aspect it is due to the need to limit the pressure drops and noise generated by the passage of air.

With regard to the aeraulic aspect, the minimum optimal value is 0.4 mm.

For the indicated upper limit value of 20 mm, it should be considered that, with the same perforation surface percentage, as the size of the holes 8 increases, the sound absorption coefficient tends to decrease; in addition, the correction coefficient of the Helmholtz resonator inlet, i.e., of the neck or hole, which, in turn, reduces the resonant frequency, increases.

Therefore, the 20 mm diameter limit is necessary to avoid excessively reducing the sound absorption coefficient.

From an aeraulic point of view, in the areas of use considered, holes of equivalent diameter greater than 20 mm are not necessary.

According to a version of the present invention, the multifunction panel 1 can be prepared with a predetermined perforation of the first holes 4 of the first layer 3 and of the second holes 8 of the third layer 7 and kept ready in the warehouse.

When the acoustic and/or air conditioning requirements require a greater number of first holes 4 of the first layer 3 and/or second holes 8 of the third layer 7, these can be added with a subsequent mechanical processing.

Furthermore, the multifunction panel 1 can comprise means for totally and or partially selectively closing (not shown) at least the first holes 4 of the first layer 3 and/or at least the second holes 8 of the third layer 7: such closing means allow to completely and/or even only partially cover predetermined first holes 4 and/or second holes 8.

By completely closing predetermined first holes 4 and/or second holes 8, it is possible to vary the number of cells 6 placed in communication with the interspace 2 and/or placed in communication with the internal environment, so as to vary the number of passages for air transit and/or the number of Helmholtz resonators.

By closing predetermined first holes 4 and/or second holes 8 it is possible to vary the air flows and/or the geometry of the Helmholtz resonators, varying the resonance frequencies thereof.

Such closing means can for example consist of caps applicable individually on the first and second holes 4 and 8, or of perforated and for example associated movable and/or sliding grids on the first layer 3 and/or on the third layer 7, and can be of another suitable type.

The aforementioned interspace 2 can comprise a box-like body, as shown in FIG. 1, or can be defined by the gap between the panel 1 itself and the fixed parts P of the internal environment on which it is installed, as shown in FIG. 2; such fixed parts P can for example be walls of the internal environment.

The interspace 2 is placed in communication with a ventilation and/or air conditioning unit, and for example constitutes the plenum of said ventilation and/or air conditioning unit.

The interspace 2, and/or the first layer 3, and/or the second layer 5 and/or the third layer 7 can be made of various materials, for example chosen from metal, and/or mineral, and/or synthetic materials, and/or composites, and/or paper, and/or wood, and/or still other suitable materials. For example, the first layer 3 and/or the second layer 7 can be made of perforated sheets.

The type of surfaces of the layers 3 and 7 also determines the emission capacity and thermal absorption by radiation of the panel: in this regard the main features are the surface finish/roughness and the colour.

As seen, the multifunction panel 1 allows to simultaneously obtain the correct ventilation/air conditioning of the internal environments of buildings, ensuring optimal control of air flows by virtue of the passages identified by the cells 6 placed in selective communication with the interspace 2 and the internal environment, and the improvement of the acoustic features of these environments, as it allows to absorb a wide range of sound waves of different frequency, as it comprises a plurality of Helmholtz resonators having different resonance frequency, and/or allows to vary the shape thereof to consequently differentiate the resonance frequency.

Furthermore, the multifunction panel 1 is, as seen, differently configurable, therefore depending on the specifications required for the internal environments where it is to be installed, since specific shapes, dimensions and distribution of the first holes 4, of the cells 6 and of the second holes 8 can be studied, and the cells 6 can be selectively placed in communication or not with the first holes 4 and the second holes 8, so as to define passages for the transit of air and/or Helmholtz resonators at different frequencies.

Moreover, the multifunction panel 1 being self-supporting and creatable in large sizes, allows to considerably reduce the need for additional structures and installation frames for the fixing to fixed parts P of the internal environments, with respect to the other known systems which use perforated panels for the introduction of air into the environment.

The multifunction panels 1 can have variable dimensions, depending on the specifications required, and can also be scalable, i.e., they can be cut at the time of installation, so as to easily adapt them even at the moment to any installation need.

From the aeraulic and acoustic point of view, the panels according to the present invention have numerous advantages.

In fact, the panels of the present invention have the following main features which can be modulated and changed to obtain the desired effects of air conditioning and acoustic absorption:
the shape and size distribution of the first holes 4 of the first layer 3 facing the interspace 2;
the size (width and height) and shape of the cells 6 of the second layer 5;
the distribution, shape and size of the second holes 8 of the third layer 7 facing the environment.

By virtue of the modulation and variation of these features, the following is determined:
the number of cells 6 which connect the interspace 2 with the environment (cells of the first type), and
the resulting number of cells 6 which remain closed towards the interspace 2, which, however, are provided with holes 8 in communication with the environment (cells of the second type), and
the number of any cells which remain closed both towards the interspace 2 and towards the environment (cells of the third type).

In almost all cases, a modulation will be sought between the above three features so as not to have cells 6 which remain closed both towards the interspace 2 and towards the environment (cells of the third type).

The cells of the first type perform the aeraulic function, air passage of the air conditioning system from the interspace 2 towards the environment, and/or the acoustic function, forming a Helmholtz resonator together with the interspace 2 behind.

The cells of the second type perform only the function of acoustic absorption as Helmholtz cells.

The cells of the third type normally perform only the structural support function of the panel and do not perform aeraulic or acoustic absorption functions.

An important feature of the panel according to the present invention is that the greater sound absorption efficiency of the cells of the first type is at a lower frequency with respect to the cells of the second type.

The combination of the acoustic features of the cells of the first and second type allows to obtain an expansion of the effective sound absorption frequency range.

This also ensures that, if said multifunction panels are used with the interspace 2 not connected to an air supply or suction, the advantageous feature of performing a soundproofing function with an extended band of soundproofed acoustic frequencies is also maintained.

Furthermore, the first holes 4, both those present on the first layer 3 facing the interspace 2, and the second holes 8 present on the third layer 5 facing the environment, can also be of various sizes and/or shapes.

Furthermore, the depth of the interspace 2 can also be differentiated along the surface of the panel 1.

By modulating and varying these features it is possible to extend, without limits or restrictions, the surfaces of the environment affected by the panels to all the available ceiling and wall parts.

Depending on the configuration chosen according to the specific needs of the environment to be served, it is also possible to keep the aeraulic function active on all the panels, without having to increase the total air introduction flow rate necessary to maintain a correct ventilation efficiency and temperature uniformity for the internal environment.

In this case, by virtue of the extension and uniform distribution of the surface, maximum acoustic absorption, thermo-hygrometric well-being results can be obtained with uniform and advantageous average radiant surface temperatures, as well as air renewal.

By virtue of these features of the first and the second holes, it is possible to obtain specific aeraulic effects—any inductive effects of the air introduced by specific holes—and/or to obtain a wider range of effective sound absorption frequencies.

Another advantage of the multifunction panel according to the present invention is the possibility of obtaining low operating noise and reduced necessary static pressure, with consequent low energy consumption, even at specific high air flow rates (m3/h per m2 of panel surface).

Furthermore, the multifunction panel according to the present invention allows to obtain correct operation even at specific very low air flow rates, i.e., m3/h per m2.

Another advantage of the multifunction panel according to the present invention, in the case that it is made entirely of materials with high thermal conductivity, such as aluminium, is that, by virtue of the large total heat exchange surface, given by the sum of the surface of the first layer 3, the surface of the second layer 5, i.e., the surface of the walls of the cells 6, and the surface of the third layer 7, a high heat exchange is obtained between the supply air introduced into the interspace 2 (coming from the air conditioning system) and the environment, without having to resort to a particularly whirlwind and/or high-speed air flow on the surface of the first layer 3 above the panel, oriented towards the interspace 2, which would constitute a source of noise and static pressure losses.

This aspect of the multifunction panel 1 is important, as it allows to carry out considerable heat exchanges with a large surface area and with even a radiant component with the environment before the supply air for air conditioning, arriving from the interspace 2, moves away from the surface of the layer 7 of the panel towards the environment.

Said heat exchanges occur already in part inside the interspace 2 on the surface of the layer 3 of the panel facing the interspace itself, they continue along the thickness of the panel by virtue of the surfaces of the walls of the cells 6 which constitute the honeycomb structure, as well as in adhesion and in the immediate vicinity of the external surface of the layer 7 of the panel facing the environment.

Such an anticipation of the heat exchange, which occurs even before the air for air conditioning moves away from the external surface of the panel itself, allows the following advantages to be obtained.

During cooling, since the heat exchange described above has already occurred by absorbing part of the heat from the environment, the surface temperature of the panel and the temperature of the air for air conditioning which moves away from its surface facing the environment, are already considerably less cold than the air for air conditioning which initially entered the interspace 2.

In fact, it has been verified during laboratory tests that said panel surface temperature and said air temperature for air conditioning assume an intermediate value between the air temperature for air conditioning in the interspace 2 and the temperature of the environment. This prevents, together with the low speed and the correct distribution of the air exiting the panel, any possible disturbance to the occupants, even in its immediate vicinity, also prevents any possible condensation on the surface of the panel itself.

During heating, since the heat exchange previously described has already occurred, yielding part of the heat to the environment, the surface temperature of the panel and the air temperature for air conditioning which moves away from its external surface, are already considerably less hot than the conditioned air initially input in the interspace 2, as verified during laboratory tests.

In such laboratory tests it was also found, under average operating conditions, that the air exiting the panel just a few centimetres away from its surface facing the environment is on average only 2-3° C. hotter than the ambient temperature, but in many applications even lower, thus preventing harmful thermal stratifications.

Furthermore, as already described above, an appropriate choice of the finish, roughness and colour of the panel surface allows to increase the magnitude of the heat exchange by radiation with the environment.

By virtue of the large surfaces reachable by the multifunction panels with a honeycomb structure, the well-being of occupants is also ensured by the radiant effect which, by exchanging heat by radiation also with the other surfaces of the room, makes the total average radiant temperature of the surfaces of the room more favourable and more uniform for the comfort of the occupants.

Another advantage of the multifunction panel according to the present invention is given by the combination of different features: the possibility of diffusing air in the environment and at the same time having air conditioning features also with a radiant component and high soundproofing features specifically suitable for the type of room served, being provided with a self-supporting structure, which can be made and installed with formats having a high unit surface, with sides also in the order of 3-4 metres, without being subject to deformation problems due to the weight thereof and the thrust of the air which passes through it.

Still another advantage of the multifunction panel according to the present invention is the possibility of being easily adaptable by cutting to size even during installation.

Modifications and variants of the invention are possible within the scope of protection defined by the following claims.

The invention claimed is:

1.-19. (canceled)

20. A multifunction panel, installable in an internal environment of a building, on a ceiling and/or on a wall, said multifunction panel having faces with a predetermined surface and defining an interspace at least for introduction or suction of ventilation and/or conditioning air, said multifunction panel comprising:
a first layer, having a surface substantially equal to the predetermined surface of a face of said multifunction panel and a distribution of first shaped through-holes a second layer defining a plurality of cells; and
a third layer, having a surface substantially equal to the predetermined surface of another face of said multifunction panel and a distribution of second shaped through-holes;
wherein said first layer faces said interspace, said second layer has the cells defining a honeycomb, or ribbed, structure interposed between said first layer and said third layer, said third layer facing said internal environment,
wherein at least one cell comprise a first open end facing said first layer and a second open end opposite the first open end and facing said third layer, wherein said first holes and said second holes being selectively open at said first ends and at said second ends of respective cells, so as to create at least a first configuration of at least one cell providing for a passage of air between said interspace and said internal environment, or vice versa, when at least one of said first holes opens at said first end and at least one of said second holes opens at said second end so as to constitute a Helmholtz resonator, and to further create a Helmholtz resonator,
wherein at least one cell creates the Helmholtz resonator by having said second holes which opens only at said second end and none of said first holes open at said first end,
wherein a ratio, expressed as a percentage, between a total surface of said first holes and a total surface of said first layer is between 0.1% and 73%, and
wherein the first holes have a predetermined first diameter between 0.4 mm and 20 mm when circular, or said first holes are made to have areas corresponding to circles of a diameter between 0.4 mm and 20 mm if the first holes have shapes other than circular.

21. The multifunction panel according to claim 20, wherein a ratio, expressed as a percentage, between a total surface of said second holes and the total surface of said third layer is between 0.1% and 20%, and wherein the second holes have a predetermined second diameter between 0.1 mm and 20 mm when circular, or said second holes are made to have areas corresponding to circles of a diameter between 0.1 mm and 20 mm if the second holes have shapes other than circles.

22. The multifunction panel according to claim 21 wherein some the second holes are aeraulic-acoustic holes and other second holes are exclusively acoustic holes, and wherein a ratio, expressed as a percentage, between a total surface of said aeraulic-acoustic second holes and the total surface of said third layer is between 0.1% and 20%.

23. The multifunction panel according to claim 20, wherein said second layer comprises cells with a height between 5 mm and 100 mm and a pitch between 5 mm and 40 mm, said cells having a hexagonal, square, rectangular, quadrangular, circular, or ribbed shape.

24. The multifunction panel according to claim 20, wherein, at said second end of at least one first respective cell of said second layer, a plurality of said second holes of said third layer are completely and/or partially open, and/or wherein at said first end of at least one second respective cell of said second layer a plurality of said first holes of said first layer are completely and/or partially open.

25. The multifunction panel according to claim 20, wherein said first, second, and third layers comprise materials with high thermal conductivity, so as to cause a high thermal exchange between the air for air conditioning and the multifunction panel, and wherein said first layer and said second layer have surface features which also determine an emission and thermal absorption by irradiation capacity of the multifunction panel.

26. The multifunction panel according to any claim 20, wherein at least one of said first holes of said first layer opens completely and/or partially at a plurality of said first ends of said respective cells of said second layer and/or at least one of said second holes of said third layer opens completely and/or partially at a plurality of said second ends of said respective cells of said second layer.

27. The multifunction panel according to claim 20, wherein said first holes of said first layer, and/or said second holes of said third layer, and/or said cells of said second layer and/or said interspace have shapes, dimensions and distribution configured so as to allow a passage of different pre-established air flows and/or so as to create the Helmholtz resonators of different pre-established resonance frequencies.

28. The multifunction panel according to claim 20, further comprising at least a fourth porous coating layer associated at least with said third layer.

29. The multifunction panel according to claim 20, further comprising at least a fifth soundproofing layer associated at least with said first layer.

30. The multifunction panel according to claim 20, further comprising selective total and/or partial closing means for at least one of said first holes of said first layer and/or for at least one of said second holes of said third layer.

31. The multifunction panel according to claim 20, wherein said interspace comprises a box-shaped body or is defined by a gap between said multifunction panel and fixed parts of said internal environment on which said multifunction is installed.

32. The multifunction panel according to one of claim 20, wherein said interspace is configured as a plenum of a ventilation and/or air conditioning assembly.

33. The multifunction panel according to claim 20, wherein said first layer, or said first layer and said third layer, or said third layer, are made as transparent, white or colored plates, permeable to light, and/or wherein the first holes and/or the second holes allow a passage of light, further comprising lighting fixtures inserted in said interspace or in said cells, whereby said multifunction panel is configured to further operate as a lighting fixture.

34. A multifunction panel, installable in an internal environment of a building, on a ceiling and/or on a wall, said multifunction panel having faces with a predetermined surface and defining an interspace, said multifunction panel comprising:
a first layer, having a surface substantially equal to the predetermined surface of a face or said multifunctional panel and a distribution of first shaped through-holes
a second layer defining a plurality of cells; and
a third layer, having a surface substantially equal to the predetermined surface of another face of said multifunctional panel and a distribution of second shaped through-holes
wherein said first layer faces said interspace, said second layer has the cells defining a honeycomb, or ribbed, structure interposed between said first layer and said third layer, said third layer facing said internal environment,
wherein at least one cell comprises first open ends facing said first layer and second open ends opposite to the first open end and facing said third layer,
wherein said first holes and said second holes being selectively open at said first ends and at said second ends of respective cells, so as to create at least a first configuration of at least one cell to put said internal environment in communication with said interspace, when at least one of said first holes opens at said first end and at least one of said second holes opens at said second end, so as to constitute a Helmholtz resonator, and to further provide a Helmholtz resonator wherein at least one cell creates the Helmholtz resonator by having said second holes that are open only at said second end and none of said first holes that are open at said first end, and
wherein said first holes of said first layer, and/or said second holes of said third layer, and/or said cells of said second layer and/or said interspace have shapes, dimensions and distribution configured to obtain Helmholtz resonators of different pre-established resonance frequencies to soundproof different sound frequencies.

35. The multifunction panel according to claim 34, further comprising at least a fourth porous coating layer associated at least with said third layer.

36. The multifunction panel according to claim 34, further comprising at least a fifth soundproofing layer associated at least with said first layer.

37. The multifunction panel according to claim 34, wherein, at said second end of at least one first respective cell of said second layer, a plurality of said second holes of said third layer are completely and/or partially open, and/or wherein at said first end of at least one second respective cell of said second layer a plurality of said first holes of said first layer are completely and/or partially open.

38. The multifunction panel according to claim 34, wherein at least one of said first holes of said first layer opens completely and/or partially at a plurality of said first ends of said respective cells of said second layer, and/or wherein at least one of said second holes of said third layer opens completely and/or partially at a plurality of said second ends of said respective cells of said second layer.

39. The multifunction panel according to claim 34, wherein said interspace comprises a box-shaped body or is defined by a gap between said multifunction panel and fixed parts of said internal environment on which said multifunction is installed.

40. The multifunction panel according to claim 34, wherein said first layer, or said first layer and said third layer, or said third layer, are made as transparent, white or colored plates permeable to light, and/or wherein the first holes and/or the second holes allow a passage of light, further comprising lighting fixtures inserted in said interspace or in said cells, whereby said multifunction panel is configured to further operate as a lighting fixture.
